(19) United States
(12) Patent Application Publication
(10) Pub. No.: US 2011/0168155 A1
(43) Pub. Date: Jul. 14, 2011

(54) GRILL PEDESTAL ASSEMBLY

(75) Inventor: Christopher J. Gallo, North Canton, OH (US)

(73) Assignee: HEAT SURGE, LLC, Canton, OH (US)

(21) Appl. No.: 12/687,227

(22) Filed: Jan. 14, 2010

(51) Int. Cl. A47J 37/07

(52) U.S. Cl. 126/25 AA; 126/9 R

(57) ABSTRACT

The present invention relates to a grill pedestal assembly which allows the grill portion to be selectively removed, whereby the grill remains usable for grilling purposes. The present invention further allows the pedestal portion to be collapsed into itself to require a much smaller volume for shipping and storage by rotating the neck portion and telescopically lowering the neck and shelf into the body. The required volume is reduced further by lowering the side shelves from a generally horizontal to a generally vertical position. Finally, the present invention may include a body formed from a single piece of material, and likewise, the neck may also be formed from a single piece of material.

### BACKGROUND OF THE INVENTION

1. Technical Field

The present invention relates to a propane grill. Particularly, this invention relates to a grill pedestal assembly which includes a selectively removable grill. Specifically, the invention relates to a grill pedestal assembly which includes a pedestal which may be moved between and open position and a closed position to greatly affect the overall size of the pedestal, thereby selectively making the overall volume of the pedestal smaller for shipping and storage.

2. Background Information

The majority of gas grills follow the cart grill design concept: the grill unit itself is secured to a wheeled frame that holds the fuel tank. The wheeled frame may also support side tables and other features. The wheeled frame is typically very large and made with sturdy materials to be able to support the heavy gas tank, as well as the grill. Inasmuch as the user of the grill will be standing and manipulating the items being grilled on the grate, the frame necessarily must be around a typical user's waist height so the user doesn't have to bend over or reach higher or lower than reasonable to work with the items. This requires the frame to be built in the general height of a user's waist.

Consequently the grill frame is large and bulky throughout the manufacture and transit process, which increases shipping and storage costs for sellers. Alternatively, the manufacturer may ship the grill in pieces, requiring the user to spend a large amount of time assembling the grill after purchase.

Heretofore, existing grill pedestal assemblies have been characteristically inefficient and lacking in a method to reduce the overall size of the grill pedestal during transport, while also minimizing the time requirements necessary to assemble the grill pedestal after purchase. Therefore, the need exists for the grill pedestal assembly of the present invention.

### BRIEF SUMMARY OF THE INVENTION

The above-listed objects are met or exceeded by the present improved grill pedestal assembly, which features a grill selectively secured to a pedestal, and a neck portion which may be telescopically moved between a first position and a second position to lower the overall height of the neck and shelf.

The grill is removably secured to the shelf by way of feet extending from the bottom of the grill, and being received in complementary recesses in the shelf. Each recess includes a recess hole, whereby a foot screw is fed up through the bottom of the shelf, through the recess hole and into a threaded hole formed in the foot of the grill. As such, a user can easily secure or unsecure the grill to the pedestal as desired.

Furthermore, the shelf and neck portion may be raised and lowered into the body portion to affect the horizontal height of the pedestal. The shelf and neck is secured in the fully extended first position by abutting a neck flange onto a body flange of the body, and securing these two flanges by way of a threaded bolt, which extends downwardly from the neck flange. The neck and shelf portion is lowered into the fully retracted second position by removing the neck flange from the body flange, rotating the neck and shelf axially, and lowering the neck and shelf portion such that the neck flange passes through a body notch formed between each body flange. The user then may rotate the neck and shelf portion axially back to position the shelf in a complementary position over the base, whereby the pedestal assembly may be fitted into a rectangular shipping container having a smaller volume.

### BRIEF DESCRIPTION OF THE SEVERAL VIEWS OF THE DRAWINGS

A preferred embodiment of the invention, illustrated of the best mode in which Applicant contemplates applying the principles, is set forth in the following description and is shown in the drawings and is particularly and distinctly pointed out and set forth in the appended claims.

FIG. 1 is a perspective view of a grill pedestal assembly of the present invention showing a grill secured to a pedestal;

FIG. 2 is a perspective view similar to FIG. 1 having the grill exploded from the pedestal;

FIG. 3A is a perspective view of a shelf and a separated skirt of the present invention;

FIG. 3B is a perspective view of a neck, a body, and a base of the present invention.

FIG. 4 is a front elevational view of the present invention;

FIG. 5 is a rear elevational view of the present invention;

FIG. 6 is a right side elevational view of the present invention;

FIG. 7 is a top plan view of the present invention;

FIG. 8 is a bottom plan view of a base of the present invention;

FIG. 9 is a front elevational view of a wheel on the base with parts cut away;

FIG. 10 is a front elevational view of a foot on the base with parts cut away;

FIG. 11 is a front elevational view of a propane tank resting in a center hole of the base with parts cut away;

FIG. 12 is a cross-sectional view taken along line 12-12 of FIG. 4;

FIG. 13 is a cross-sectional view taken along line 13-13 of FIG. 12;

FIG. 14 is a cross-sectional view taken along line 14-14 of FIG. 4 and showing the alignment of the neck flanges and body flanges in the first orientation;

FIG. 15 is a cross-sectional view taken along line 15-15 of FIG. 14;

FIG. 16 is a magnified view of the encircled portion of FIG. 15;

FIG. 17 is a right side view of the present invention being tilted and pulled by a user;

FIG. 18 is a view of the grill pedestal assembly of the present invention showing the grill in phantom on the shelf, and having the grill and a gas tank removed from the pedestal and disposed therebeside;

FIG. 19 is a perspective view of the pedestal in the first position and first orientation;

FIG. 20 is a cross-sectional view similar to FIG. 15, showing the neck removed from the body;

FIG. 20A is a cross-sectional view similar to FIGS. 15 and 20, showing the neck removed from the body and the skirt separated;

FIG. 21 is a perspective view of the pedestal in the first position and second orientation;

FIG. 22 is a cross-sectional view similar to FIG. 14 showing the alignment of the body flanges and neck flanges in the second orientation;

FIG. 23 is a perspective view of the pedestal in the first orientation and moving between the first position and the second position;

FIG. 24 is a perspective view of the pedestal in the second position and first orientation; and

FIG. 25 is a perspective view of the pedestal in the fully retracted state and being loaded into a box for transport.

Similar numbers refer to similar parts throughout the drawings.

### DETAILED DESCRIPTION OF THE INVENTION

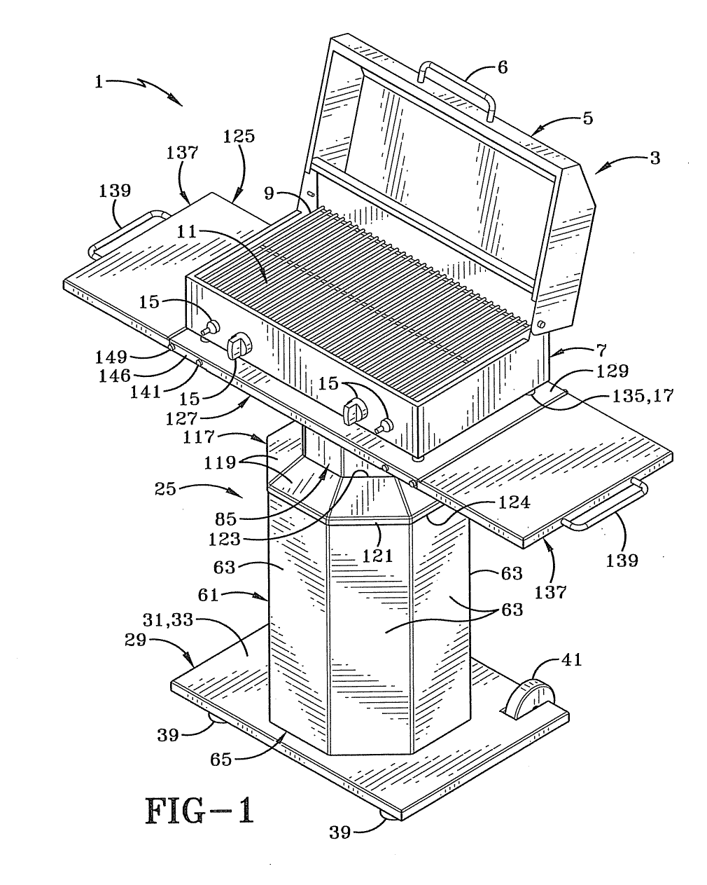

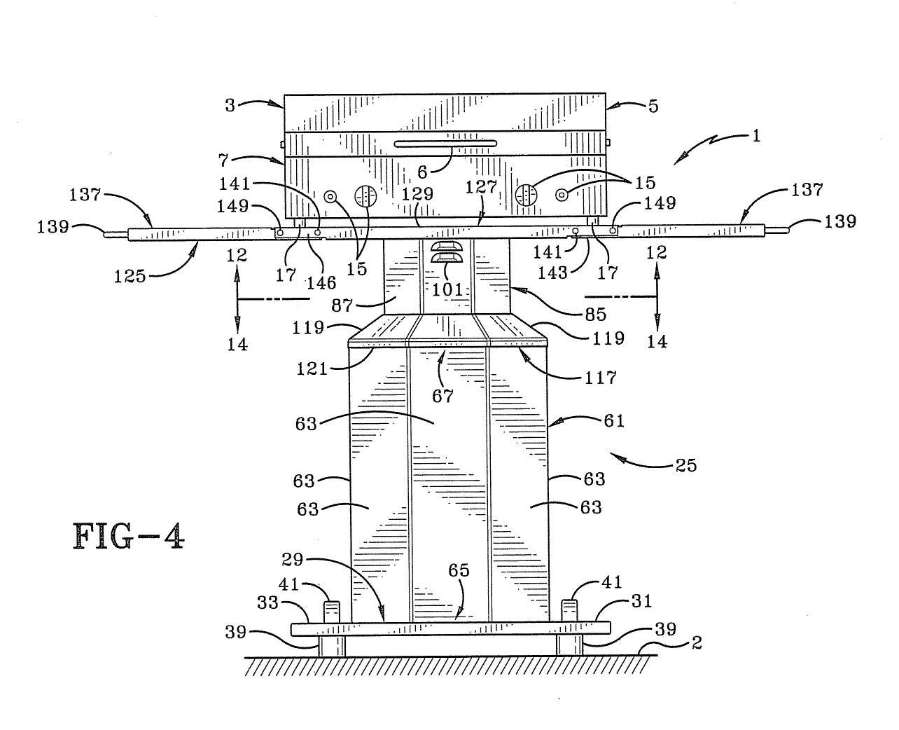

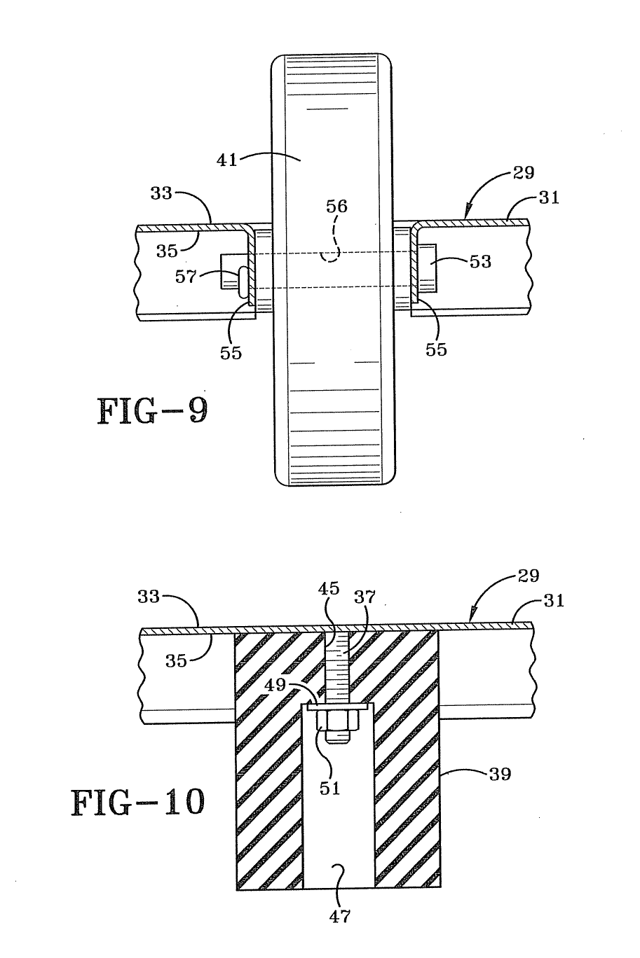

The grill pedestal assembly of the present invention is generally indicated at 1, and is shown in FIGS. 1-25. Referring to FIG. 1, grill pedestal assembly 1 is broadly comprised of a grill 3 having a lid 5 and a base 7, and a pedestal 25 having a base 29, a body 61, a neck 85, a skirt 117, and a shelf 125.

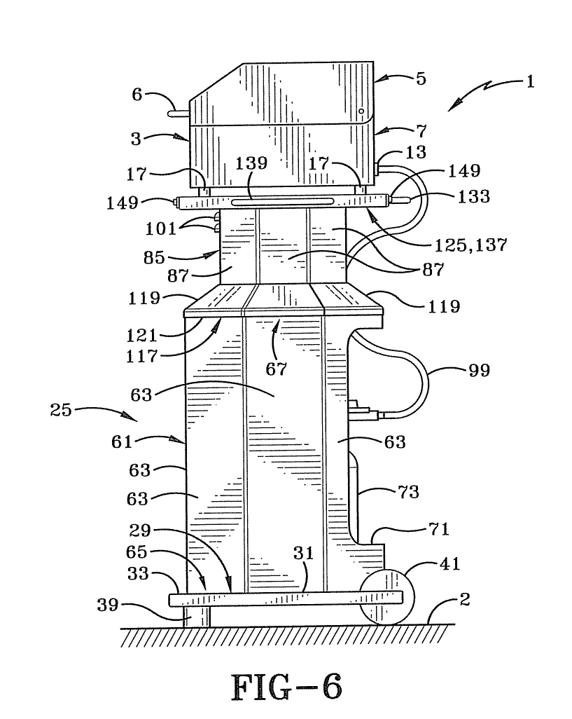

Referring to FIGS. 1, 6, and 13, grill 3 is now described in further detail. Lid 5 includes a handle 6 and is hingedly connected to base 7. Base 7 includes a removable grate 9 and defines a flame area 11 proximate grate 9, whereby flame area 11 and grate 9 are sized to provide a cooking area. Base 7 further includes a gas coupling 13 (FIG. 6), a plurality of control elements 15, and a plurality of feet 17 extending outwardly from base 7 (FIG. 13). Each of feet 17 define a threaded hole 19 extending therein and sized to receive a foot screw 21.

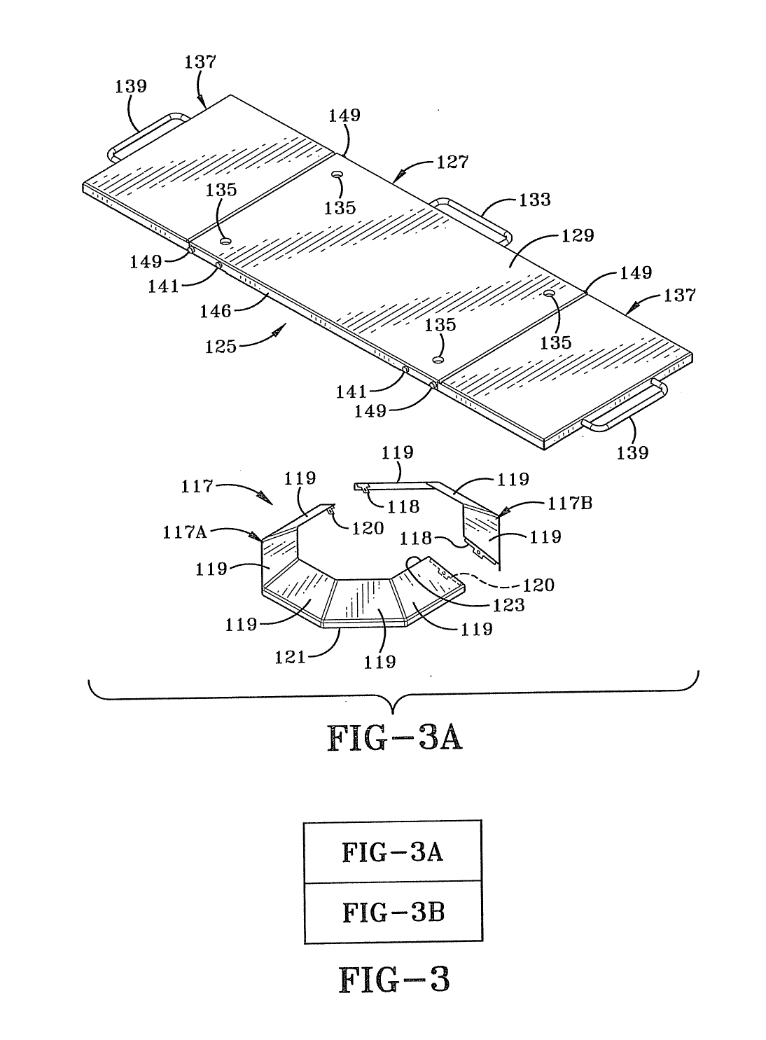

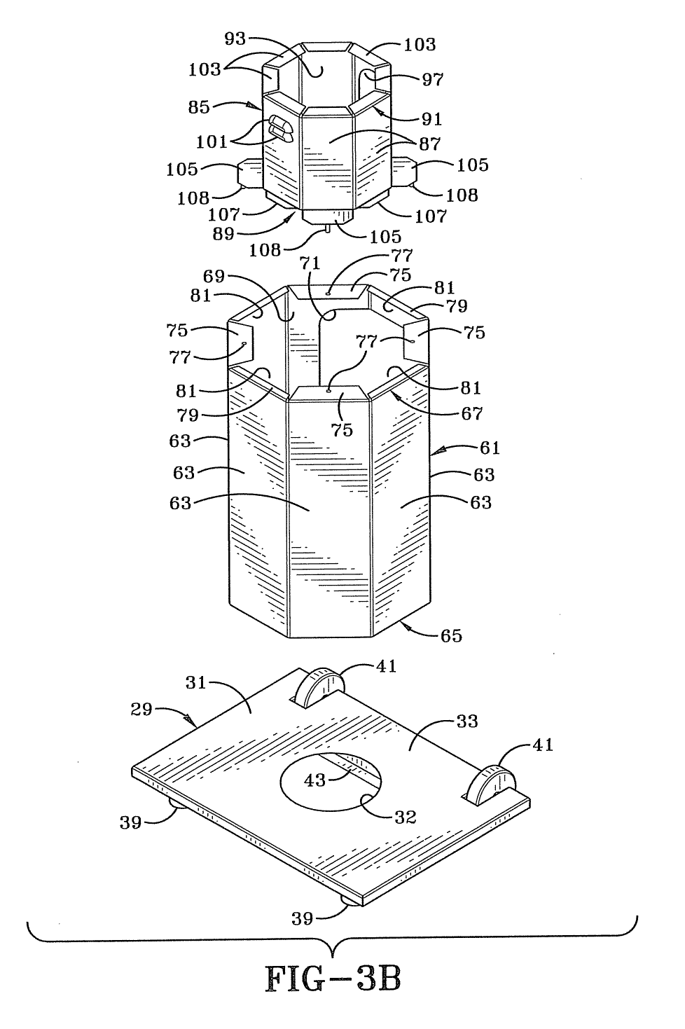

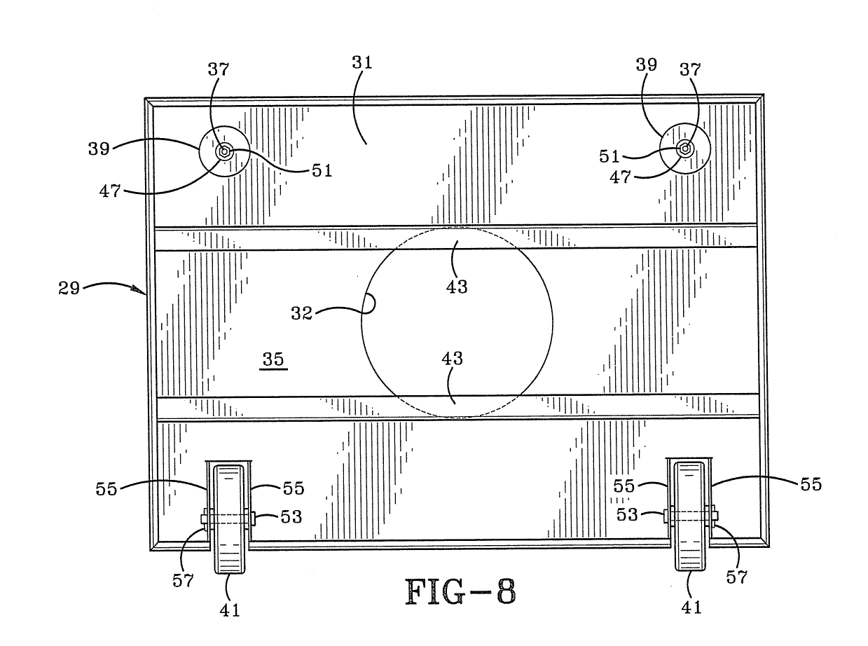

Referring to FIGS. 3B and 8-10, base 29 is now described in further detail. Base 29 includes a plate portion 31 having an upper surface 33, a lower surface 35, and a pair of threaded bolts 37 extending from lower surface 35. Plate portion 31 defines a generally circular center hole 32 extending therethrough. Base 29 further includes a pair of feet 39, a pair of wheels 41, and a pair of L-shaped brace ribs 43 extending along lower surface 35 (FIG. 8). Feet 39 are secured to lower surface 35 of plate portion 31 by way of threaded bolt 37. Bolt 37 extends through a bolt hole 45 formed in foot 39 and into a cavity 47 formed in foot 39, whereby a portion of threaded bolt 37 engages with a washer 49 and a nut 51 in cavity 47 to secure foot 39 to plate portion 31. Wheels 41 are secured to lower surface 35 of plate portion 31 within a wheel recess 54 by way of a smooth axle 53. Axle 53 extends through one of a pair of walls 55 formed in plate portion 31, into an axle hole 56 formed in wheel 41, and into the other of the pair of walls 55, whereby axle 53 is securely held by a cotter pin 57.

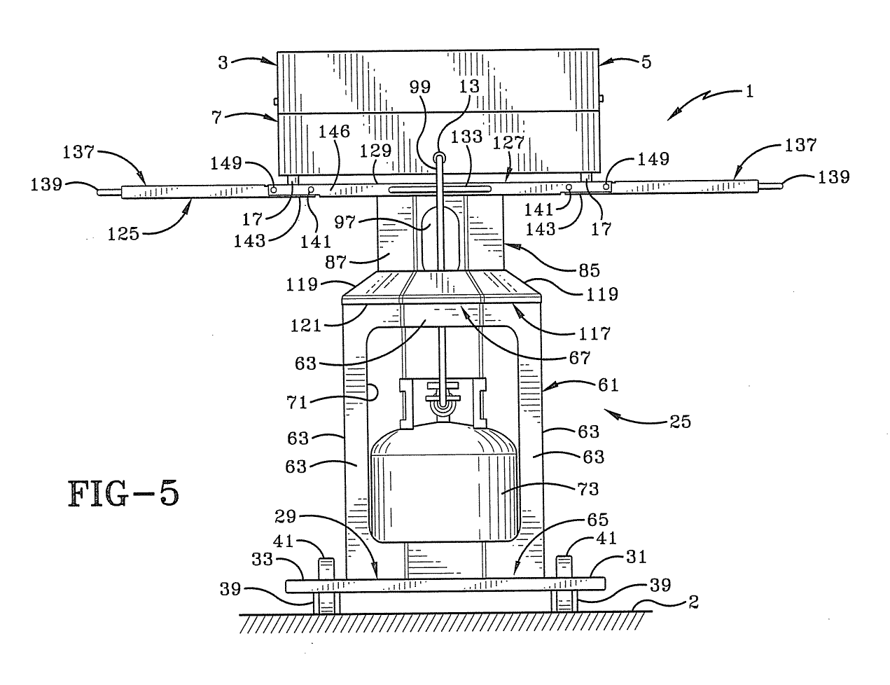

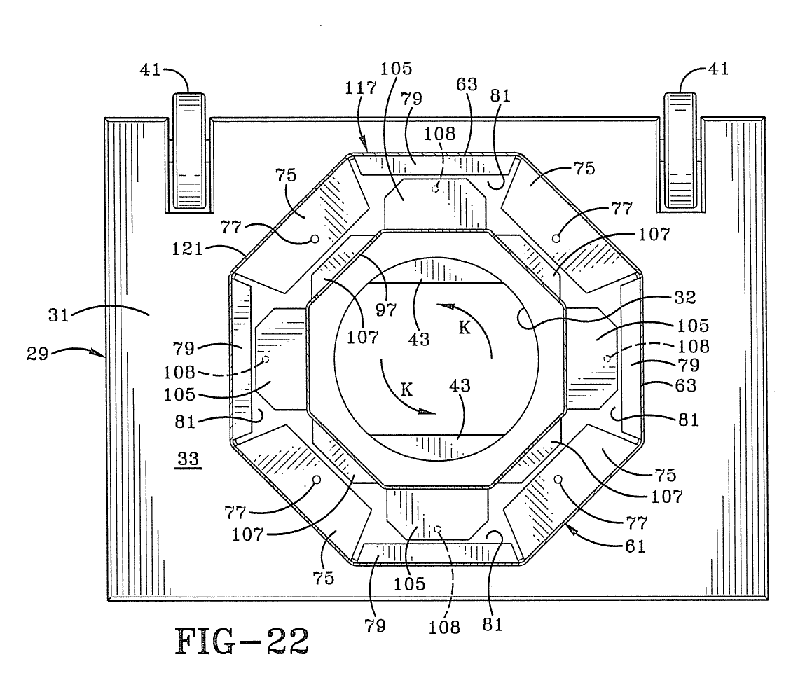

Referring to FIGS. 3B, 5, and 22, body 61 is now described in further detail. Body 61 includes a plurality of flat sidewalls 63 extending from a first end 65 to a spaced apart second end 67 of body 61, and positioned to define a hollow center 69 therein. Several sidewalls 63 further define a tank aperture 71, sized to allow a common propane tank 72 (FIG. 5) to fit therethrough and rest inside hollow center 69. Body 61 further includes a plurality of body flanges 75 proximate second end 67 of body 61 and formed as the terminal end of particular sidewalls 63. Each body flange 75 includes a flange hole 77 therethrough. Sidewalls 63 which do not terminate into body flanges 75, terminate into a plurality of lips 79, wherein lips 79 are sized smaller than body flange 75. As shown in FIG. 22, lips 79 and body flanges 75 are intermediate and alternating around second end 67 of body 61, and define a plurality of body notches 81 therebetween, wherein each body notch 81 is proximate each lip 79, and intermediate each body flange 75. First end 65 of body 61 is welded to upper surface 33 of base 29 to permanently secure body 61 to base 29. In the preferred embodiment, body 61 is formed from a single piece of material cut from a pattern, and requires only folding and drilling to achieve the shape of body 61.

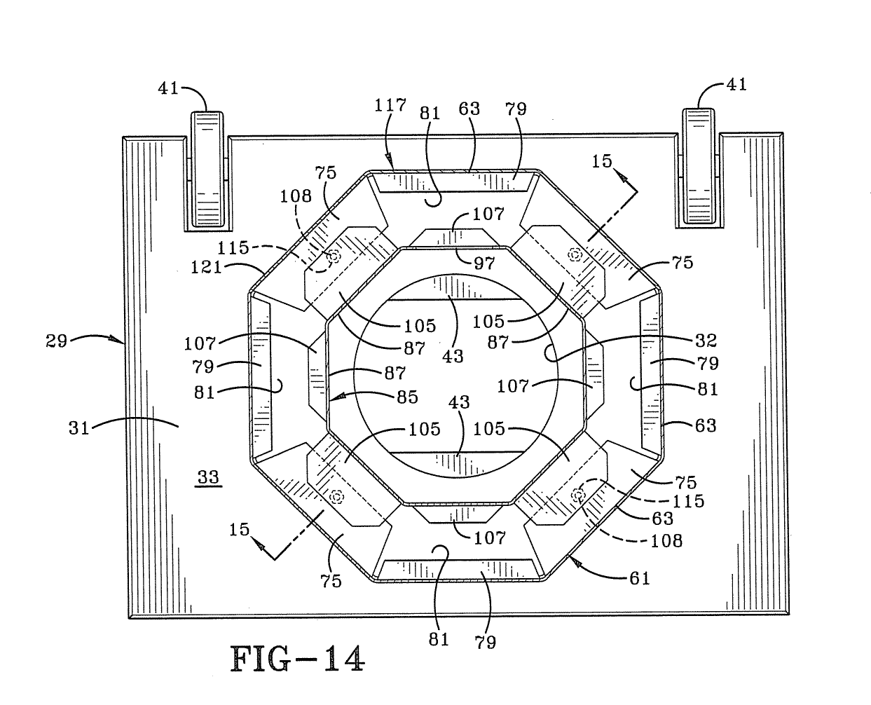

Referring to FIGS. 3B, 5, and 14-16, neck 85 is now described in further detail. Neck 85 includes a plurality of flat sidewalls 87 extending from a first end 89 to a spaced apart second end 91 of neck 85, and positioned to define a hollow center 93 therein. One particular sidewall 87 further defines a hose aperture 97, sized to allow a common propane tank hose 99 to pass therethrough and into hollow center 93. Another particular sidewall 87 includes a vent 101 sized to allow air to pass therethrough. Proximate second end 91 of neck 85, sidewalls 87 fold into a plurality of flanges 103 which together form a generally horizontal surface. Neck 85 further includes a bottom wall 109 proximate first end 89 which defines a center hole 111 (FIG. 14) therethrough. In the preferred embodiment, neck 85 is formed from a single piece of material cut from a pattern, and requires only folding and drilling to achieve the shape of neck 85.

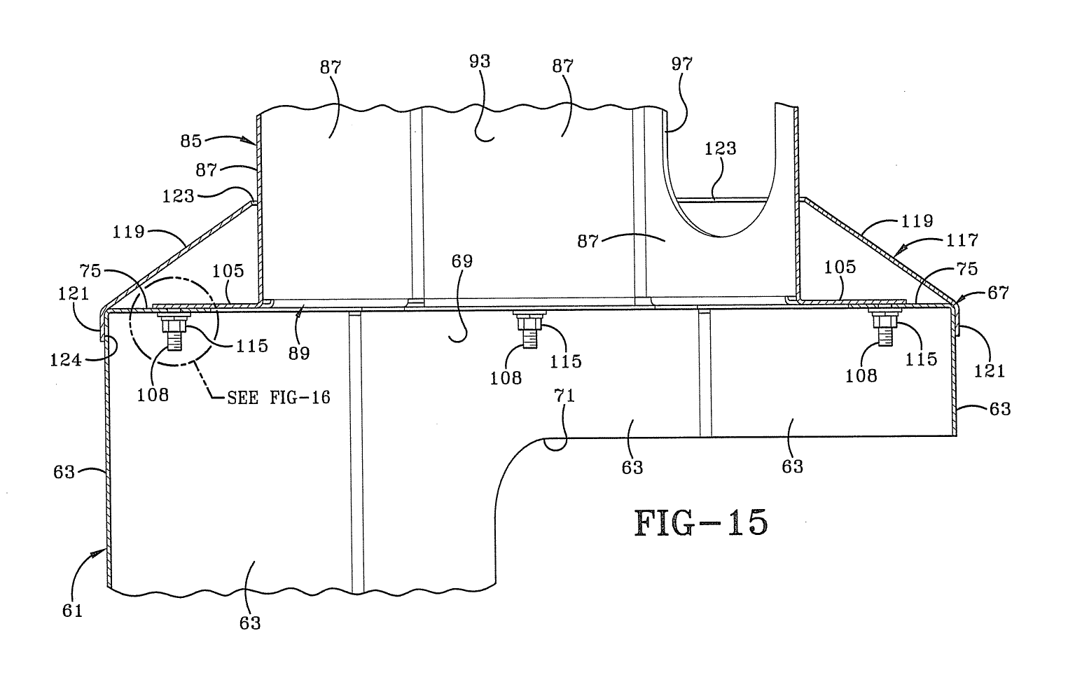

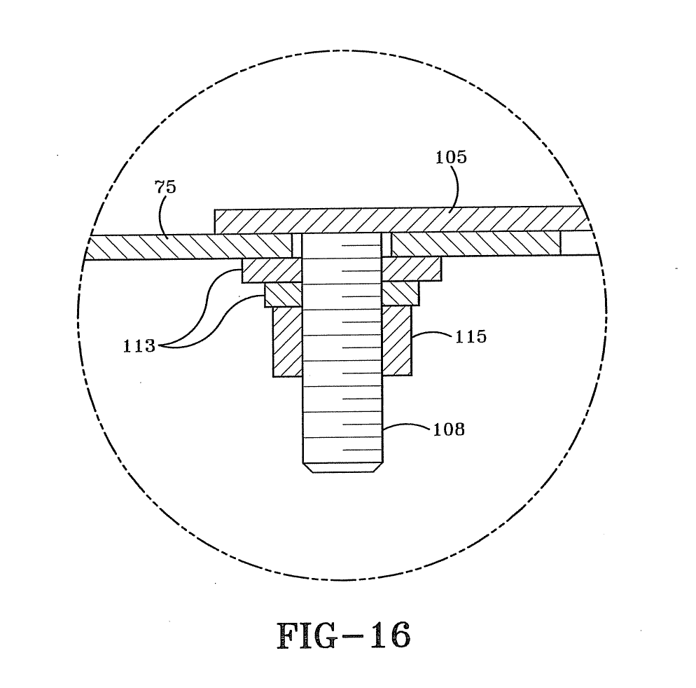

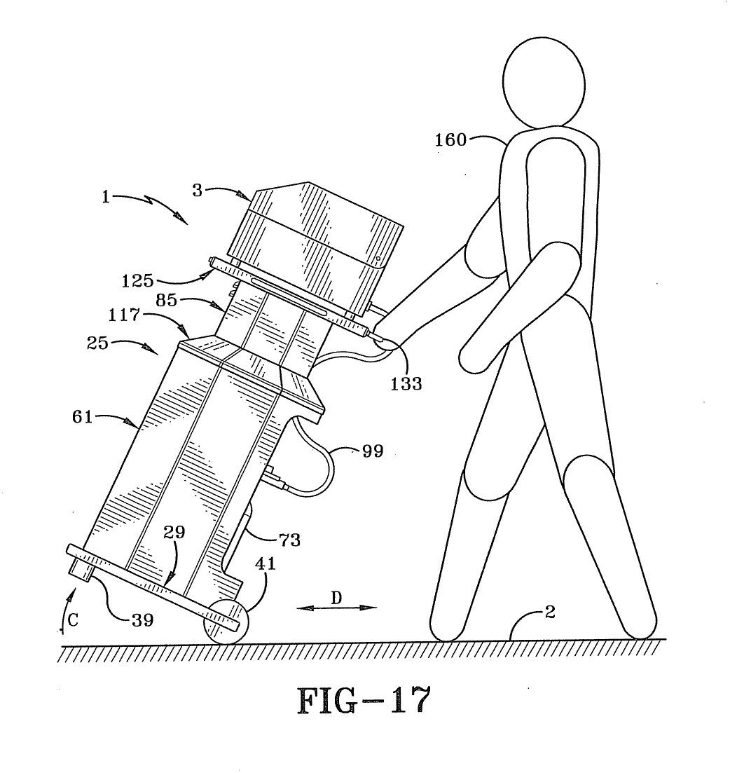

Proximate first end 89 of neck 85, alternate sidewalls 87 fold into either a neck flange 105 or a lip 107, wherein lips 107 are intermediate neck flanges 105. As shown in FIG. 14, lips 107 and neck flanges 105 alternate around first end 89 of neck 85. As shown in FIG. 14, lips 107 and neck flanges 105 define a plurality of neck notches 95 therebetween, wherein each neck notch 95 is proximate each lip 107, and intermediate each neck flange 105. Neck flange 105 includes a threaded bolt 108 sized to pass through flange hole 77 on body flange 75 of body 61. As shown in FIGS. 15 and 16, threaded bolt 108 extends from each neck flange 105, and is inserted into flange hole 77 on body flange 75 and secured by two washers 113 and a nut 115 to removably secure neck 85 to body 61. As shown in FIG. 14, neck flange 105 is sized and formed to overlap and abut body flange 75, whereby threaded bolt 108 is aligned with flange hole 77.

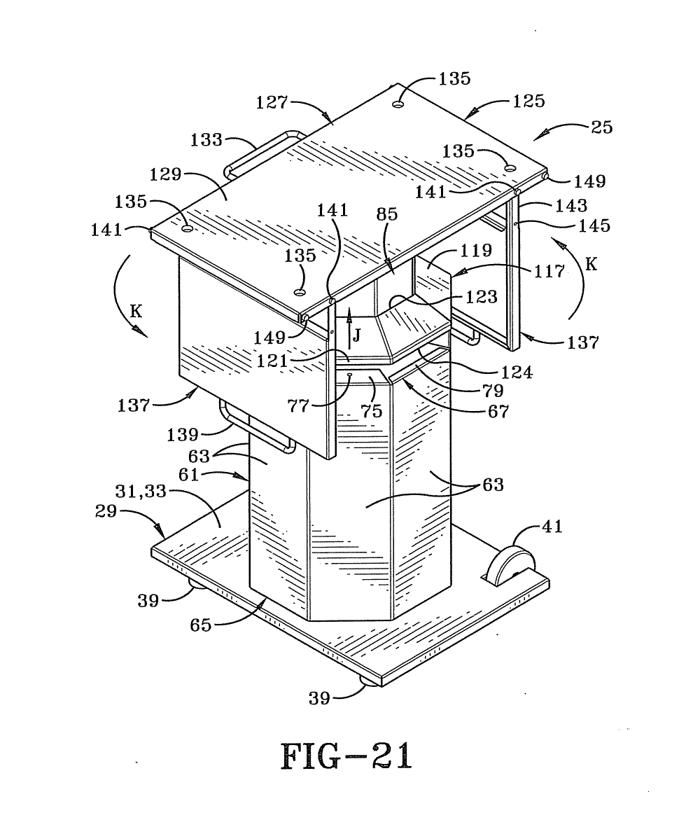

As shown in FIGS. 3A, 5, 15, 20A, and 21, a skirt 117 is movable between a raised position (FIG. 21) and lowered position (FIG. 5) and slidably abuts sidewalls 87 around the perimeter of neck 85, and defines a top opening 123 and a bottom opening 124. Skirt 117 includes an angled surface 119, which generally extends from sidewalls 87 of neck 85 to sidewalls 63 of body 61, when skirt 117 is in the lowered position. Angled surface 119 folds into a lip 121, which generally fittably abuts sidewalls 63 about bottom opening 124 when skirt 117 is in the lowered position. Skirt 117 is free to slidably rotate along the length of sidewalls 87 of neck 85 between the raised and lowered position, as top opening 123 is complementarily shaped and sized to allow sidewalls 87 to slidably fit therein.

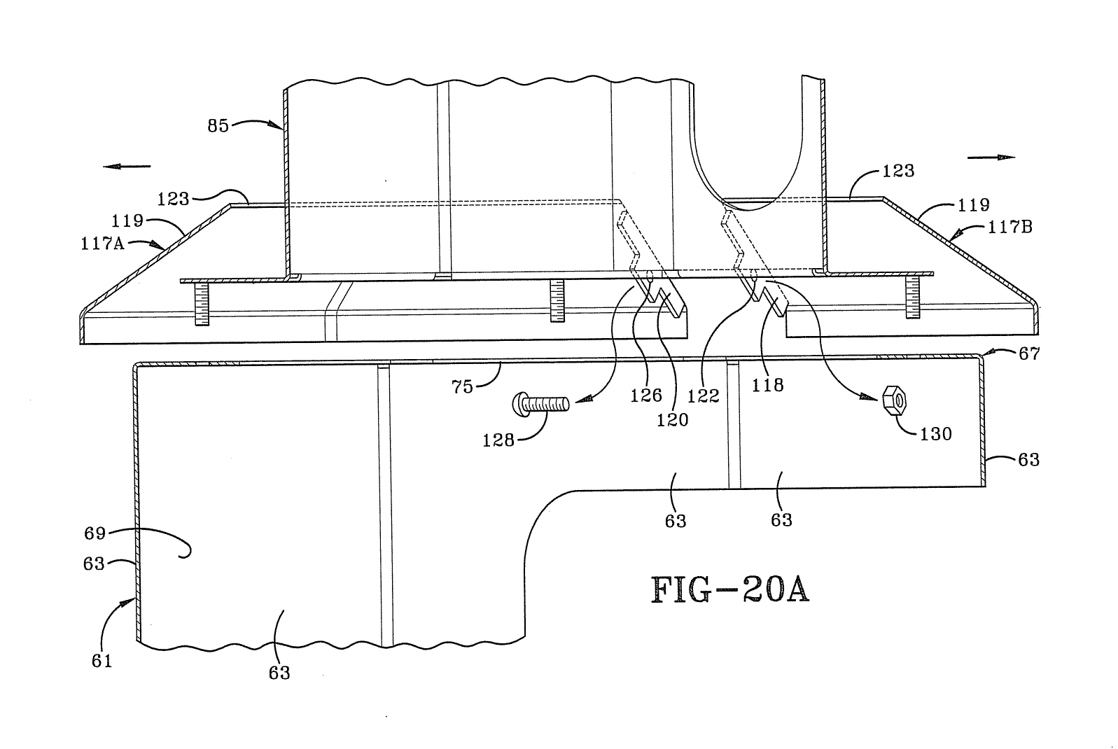

Alternatively, as shown in FIGS. 3A and 20A, skirt 117 may be removed entirely from neck 85. Skirt 117 is comprised of two parts 117A and 117B removably secured together. As shown in FIG. 20A, a sidewall 120 extends inwardly from angled surface 119 on part 117A and defines a hole 126 therein. Likewise, a sidewall 118 extends inwardly from angled surface 119 on part 117B and defines a hole 122 therein. Parts 117A and 117B are formed such that holes 126 and 122 align when parts 117A and 117B are properly positioned around neck 85, whereby a bolt 128 may extend therethrough to be secured by a removable nut 130.

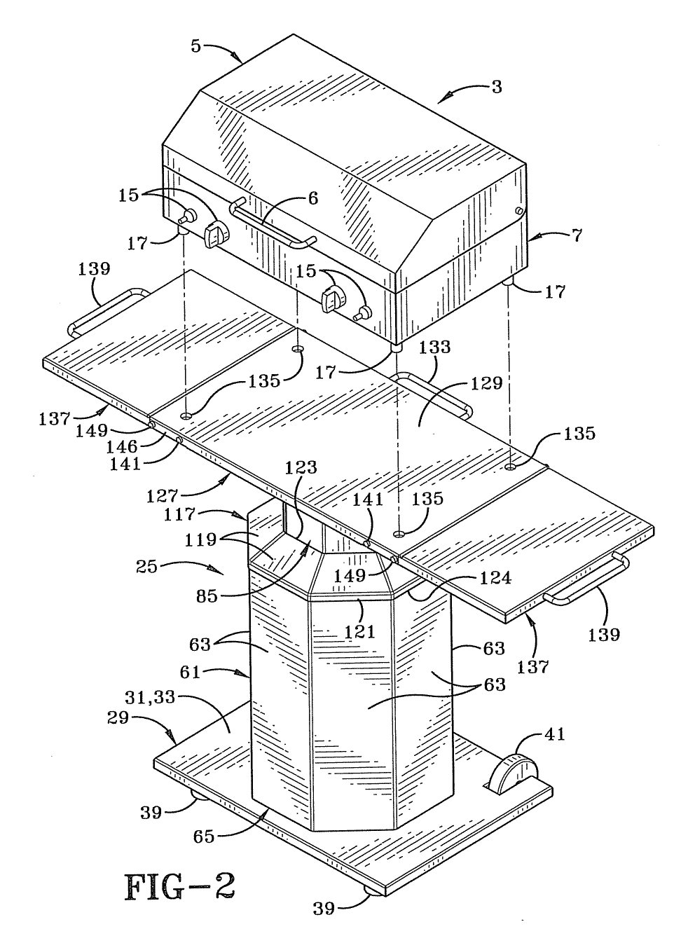

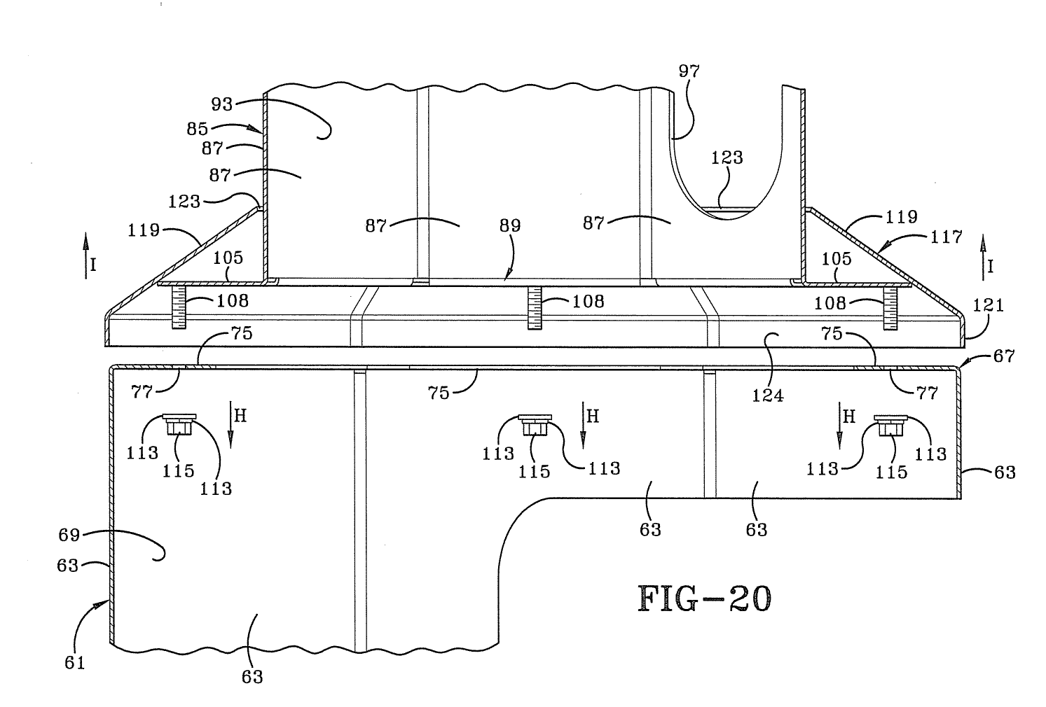

Referring to FIGS. 2, 3A, 12, 13, and 19, shelf 125 is now described in further detail. Shelf 125 includes a main portion 127 having an upper surface 129 and a lower surface 131 (FIG. 13), two opposed sidewalls 146, a handle 133 extending from one of sidewalls 146, and a plurality of foot recesses 135 defined therein. Shelf 125 further includes a pair of side shelves 137 having a handle 139. Side shelves 137 are pivotally connected to sidewalls 146 of main portion 127 about a pair of pivot pins 141 which extend through sidewalls 146 and into a pair of pivot brackets 143 disposed on side shelves 137. As shown in FIG. 19, each pivot bracket 143 includes a first brace hole 145 which aligns with a corresponding second brace hole 147 formed in sidewalls 146 of main portion 127 of shelf 125, whereby a brace pin 149 is inserted to secure side shelves 137 in a horizontal position. Brace pin 149 may be removed as desired to allow side shelves 137 to pivot about pivot pin 141 into a vertical position.

Each foot recess 135 includes a recess hole 140 sized to allow a portion of foot screw 21 to pass therethrough (FIG. 13). Foot recess 135 is sized to receive a portion of foot 17 and spaced to prevent lateral movement of grill 3. Foot screw 21 passes through recess hole 140 and into threaded hole 19 in foot 17 to securely hold grill 3 to main portion 127 of shelf 125, thereby removably securing grill 3 to pedestal 25.

As shown in FIG. 13, a pair of spaced apart L-shaped ribs 151 are disposed on lower surface 131 of main portion 127. Shelf 125 is secured to neck 85 by welding top flanges 103 of neck 85 to lower surface 131, and ribs 151 to sidewalls 87 of neck 85. Top flanges 103 provide a flat, generally horizontal surface to brace main portion 127 of shelf 125, and ribs 131 provide a flat, generally vertical surface to brace sidewalls 87 of neck 85.

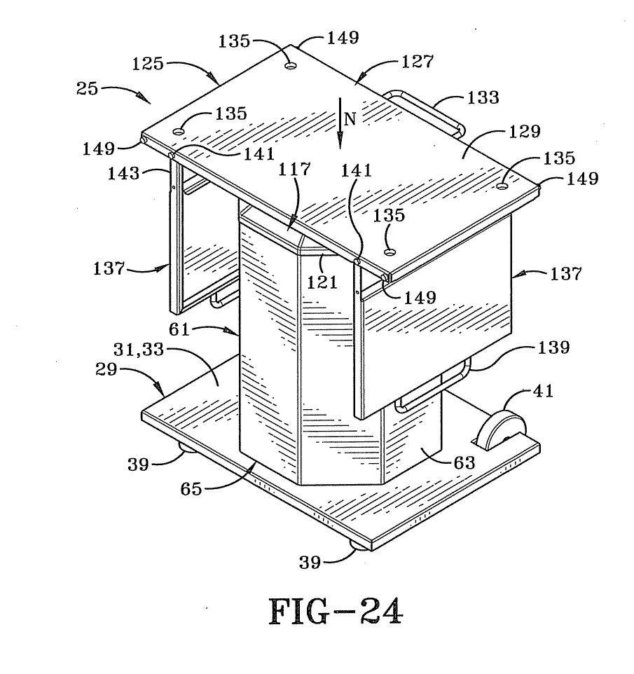

In operation, pedestal 25 of grill pedestal assembly 1 is changeable between an open position (FIG. 1) and a closed position (FIG. 24). In the open position, grill 3 is typically secured to shelf 125 and presented at a typical height for a user to operate using any methods common in the art. When pedestal 25 is in the closed position, grill 3 is separated from pedestal 25, and pedestal 25 is collapsed into a smaller shape having a lower total volume. When pedestal 25 is in the closed position, it requires much less space for storage and shipment, a very desirable feature for commercial and retail settings. Furthermore, by providing grill pedestal assembly 1 with a separable grill 3 and pedestal 25, retail establishments may sell these elements as distinct and separate items, each having a particular range of models and/or features.

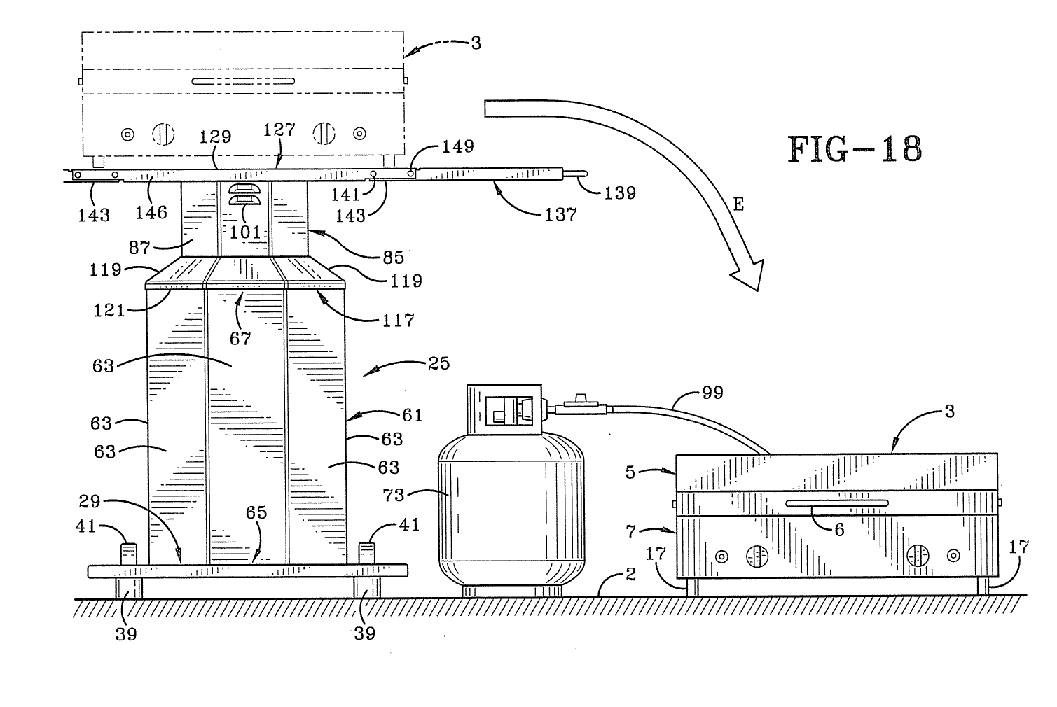

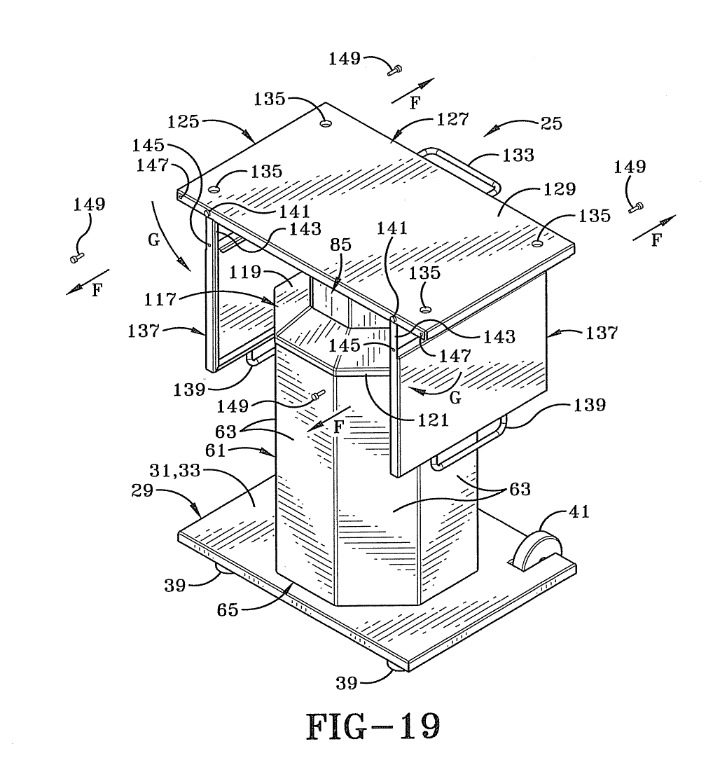

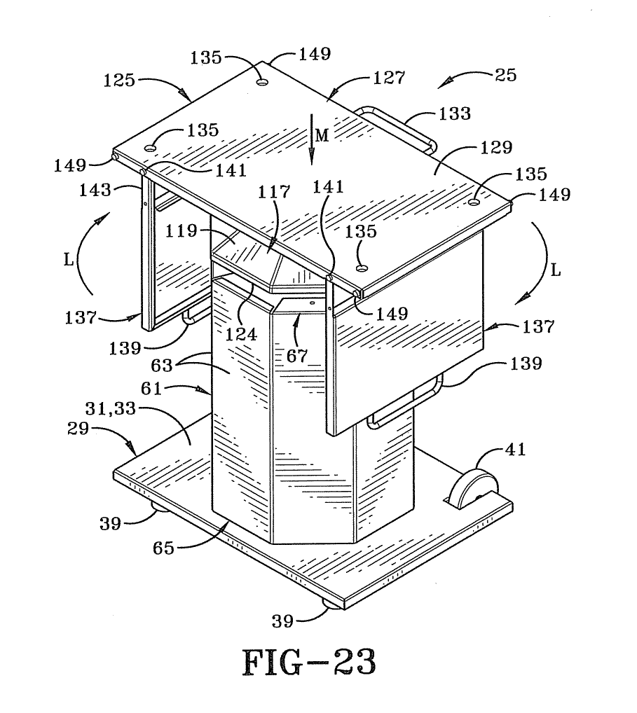

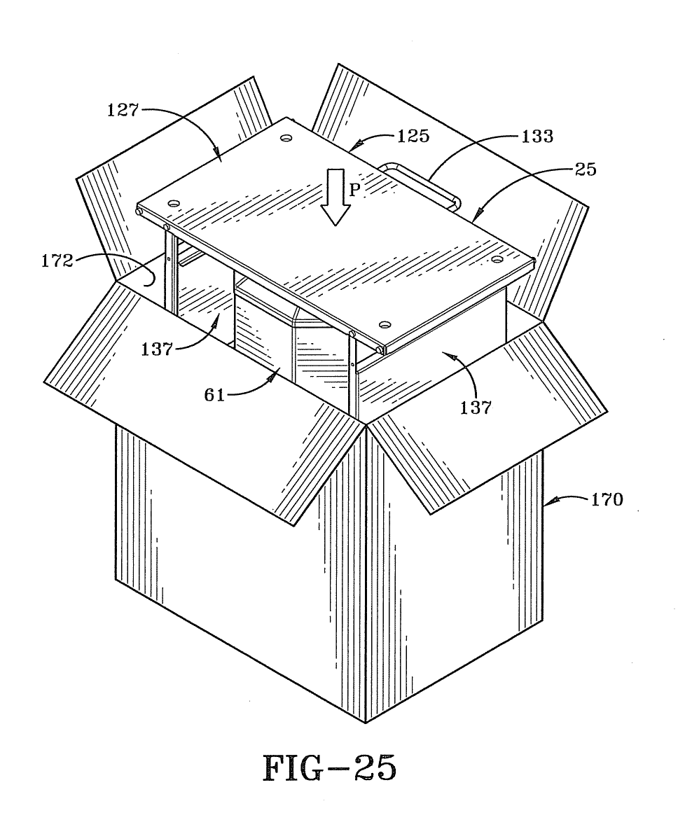

Pedestal 25 is changeable between the open position (FIG. 2) and closed position (FIG. 24) by the following general steps which will be described in greater detail below. First, the user must separate and remove grill 3 and propane tank 73 from pedestal 25 (FIG. 18). The user then lowers each side shelf 137 from a generally horizontal position (FIG. 2) to a generally vertical position (FIG. 19). Next, the user axially rotates neck 85 from a first orientation (FIG. 19) to a second orientation (FIG. 21) relative body 61. The user then telescopically lowers neck 85 from a first position (FIG. 23) to a second position (FIG. 24) relative body 61. Finally, the user then axially rotates neck 85 from the second orientation (FIG. 21) back to the first orientation (FIG. 19). Thus, the transition from the open position to the closed position is complete, and leaves pedestal 25 as having a smaller overall size and volume for storage or shipment (FIG. 25). To change pedestal 25 from the closed position to the open position, the process and steps are simply reversed.

Grill 3 is selectively secured to shelf 125 and remains secured if a user wishes to move or pivot grill pedestal assembly 1 as a unit. As shown in FIG. 17, a person 160 may tilt grill pedestal assembly 1 in the direction of Arrow C about wheels 41 and pull tilted grill pedestal assembly 1 by handle 133 in the direction of Arrow D along a surface 2. As shown in FIG. 8, wheels 41 are disposed along one of the long sides of base 29, allowing a user to pivot and pull tilted grill pedestal assembly 1 symmetrically about a center line of grill 3 like a common dolly would be used to transport an item. The novel feature of allowing grill 3 to be removed from pedestal 25 is an additional feature which does not detract from the common usage of a typical grill. Grill pedestal assembly 1 provides all of the common features typical in the art, yet provides additional unique and novel features, such as the selectively removable grill 3 portion.

Grill 3 is removed from pedestal 25 by disconnecting feet 17 from main portion 127 of shelf 125, and disconnecting propane tank hose 99 from gas coupling 13. As shown in FIG. 2, each feet recess 135 on shelf 125 aligns with one foot 17 on grill 3. As shown in FIG. 13, a portion of foot 17 extends into foot recess 135, whereby grill 3 is prevented from sliding off shelf 125. Foot recess 135 includes recess hole 140 which aligns with threaded hole 19 in foot 17, and allows foot screw 21 to secure foot 17 to shelf 125. To remove grill 3 from shelf 125, foot screw 21 is rotated to release foot screw 21 from threaded hole 19 and recess hole 140, thereby releasing foot 17 from foot recess 135. This disconnects grill 3 from shelf 135, however, grill 3 remains connected to pedestal 25 by propane tank hose 99. Propane tank hose 99 is threaded through hose aperture 97 and into hollow center 69 of body 61, where hose 99 is connected to propane tank 73. To fully release grill 3 from pedestal 25, the user must disconnect hose 99 from gas coupling 13 on grill base 7 (FIG. 6). After hose 99 is disconnected from gas coupling 13, grill 3 may be lifted off main portion 127 of shelf 135 and placed where desired by the user.

A primary feature of this invention is that grill 3 may be fully used separate from pedestal 25. As shown in FIG. 2, propane tank 73 may also be removed from pedestal 25 and reconnected with grill 3, to allow a user to use grill 3 separate from pedestal 25. As such, grill pedestal assembly 1 provides a portable style grill option for the user, whereby the user may take the more portable disconnected grill 3 on a camping trip or to a tailgate party separate from pedestal 25.

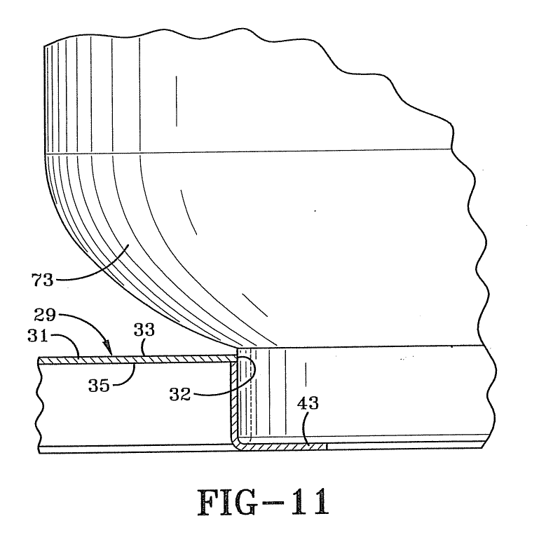

Propane tank 73 typically rests on base 29 within hollow center 69 of body 61. As shown in FIG. 11, a portion of tank 73 extends into center hole 32 whereby the portion rests on ribs 43, which stabilizes tank 73 and prevents movement within hollow center 69. Tank aperture 71, formed in body 61 is sized to allow tank 73 to pass therethrough. When the user wishes to remove tank 73 from hollow center 69, the user simply lifts tank 73 out of center hole 32 and off upper surface 33 of base 29, and pulls tank 73 through tank aperture 71. If tank hose 99 is connected to tank 73, hose 99 is pulled through hose aperture 97 and follows out of hollow center 69 of body 61 along with the movement of tank 73. Grill 3 and tank 73 are shown connected and separate from pedestal 25 in FIG. 18, and may be repositioned and used as desired.

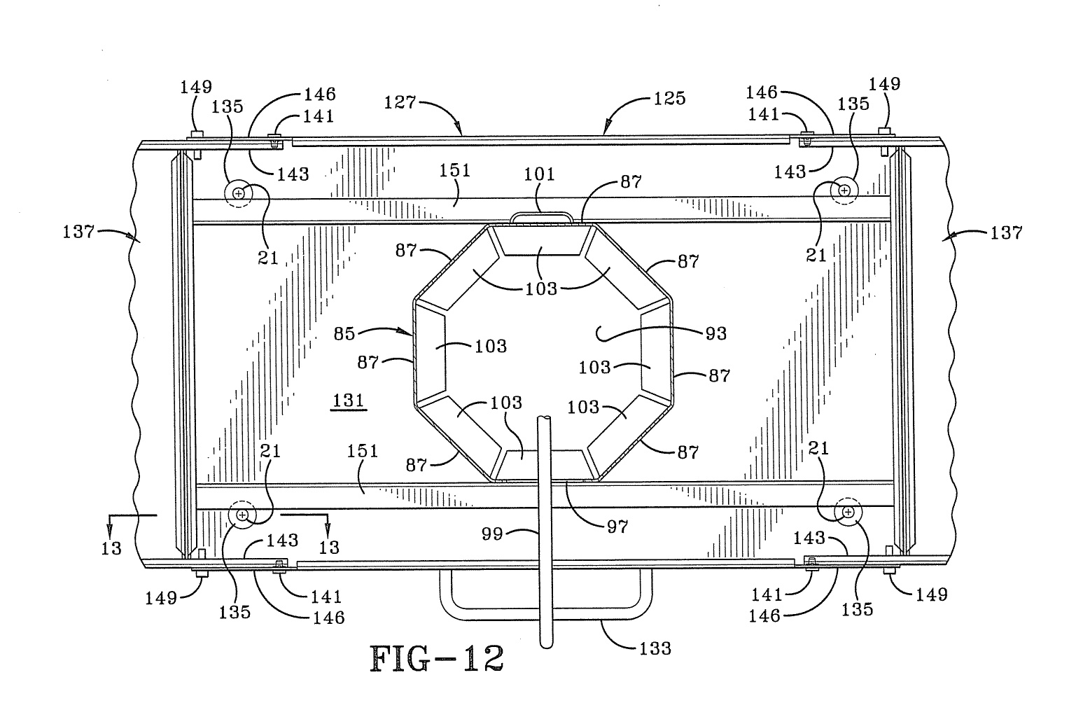

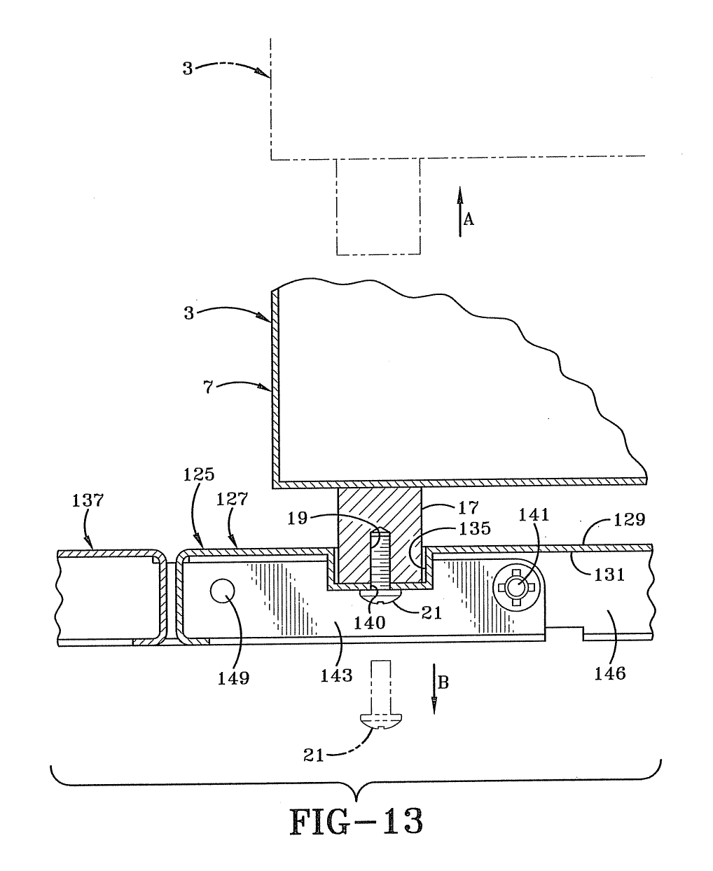

Side shelves 137 may be moved between a generally horizontal position (FIG. 2) and a generally vertical position (FIG. 19). As shown in FIGS. 12 and 13, side shelves 137 are held in the horizontal position by removable brace pin 149. Brace pin 149 extends through first brace hole 145 and into second brace hole 147 to secure pivot bracket 143 to sidewall 146 of main portion 127 of shelf 125, holding side shelves 137 in the generally horizontal position. First brace hole 145 extends through bracket 143 in side shelf 137, and is positioned to align with second brace hole 147 when side shelf 137 is in the horizontal position. As shown in FIG. 19, when brace pin 149 is removed from brace holes 145 and 147 in the direction of Arrow F, side shelf 137 is free to rotate about non-removable pivot pin 141 into the vertical position. Side shelves 137 rotate in the direction of Arrow G, and remain in the generally vertical position. As shown in FIG. 19, pivot pin 141 is positioned to allow side shelves 137 to fold and rest under main portion 127 of shelf 125 in the vertical position. This is facilitated by pivot brackets 143 extending away from side shelves 137. As shown in FIG. 13, pivot brackets 143 are sized to allow side shelves 137 to remain proximate main portion 127 while in the horizontal position. This allows side shelves 137 to pivot in towards body 61 and further compress pedestal 25 into a smaller overall size for storage or shipment.

In the open position, neck 85 is selectively secured to body 61 by way of neck flange 105 secured to body flange 75. As shown in FIG. 14, when neck 85 is in the first orientation, neck flange 105 overlaps body flange 75, whereby the threaded bolts 108 which extend from neck flange 105 align with flange hole 77. As shown in FIGS. 14-16, threaded bolts 108 extend into flange hole 77 whereby bolts 108 are secured by washers 113 and nut 115, securely holding neck flange 105 to body flange 75. Bolt 115 is unscrewed and removed, and washers 113 are removed to disconnect neck flange 105 from body flange 75. Threaded bolts 108 are shown as integrated with neck flange 105, however, they may be separate bolts or screws or any other common affixation element used in the art. Likewise, nut 115 is shown as a common hex-nut, but may be any kind of securing fastener, such as a wing-nut.

As shown in FIG. 20, to move neck from the first orientation to the second orientation, bolts 115 and washers 113 are removed in the direction of Arrow H, which frees neck 85 to be moved in the direction of Arrow I. Skirt 117 is preferably removed entirely from neck 85 by unsecuring nut 130 from bolt 128, and removing bolt from holes 122 and 126 on parts 117A and 117B, releasing skirt 117 from neck 85 (FIG. 20A). However, the user may alternatively leave skirt 117 secured around neck 85. As shown in FIG. 21, skirt 117 is moved in the direction of J, such that neck flanges 105 and body flanges 75 are revealed to the user to more easily rotate neck 85 and align body flanges 75 with body notches 81. Neck 85 is secured to shelf 125, so in rotating neck 85, shelf 125 is rotated as well. As the user rotates neck 85 in the directions of Arrow K (FIG. 21), neck flanges 105 rotate away from body flanges 85 and towards body notches 81. Body notches 81 are notched spaces between each body flange 85, sized to allow neck flanges 105 to pass thereby in a vertical direction. As the user rotates neck 85 in the axial directions of Arrow K, neck notches 95 rotate toward body flanges 75, allowing body flanges 75 to extend into neck notch 95 and not abut neck 85 while in the second orientation.

As shown in FIG. 22, neck 85 is in the second orientation. Lips 107 on neck 85 and lips 79 on body 61 are staggered in the second orientation, whereby each lip 79 is proximate one neck flange 105, and each lip 107 is proximate one body flange 75. In contrast to the first orientation, where neck flanges 105 are sized to overlap body flanges 75, in the second orientation, neck flanges 105 are rotated away from body flanges 75 and rest in corresponding notches 81 in a non-overlapping position with corresponding lips 79.

When neck 85 is in the second orientation, neck flanges 105 may vertically pass through body notches 81. Passing neck flanges 105 through body notches 81 allows neck 85 to move from the first position to the second position by telescopically lowering a portion of neck 85 into hollow center 69 of body 61. As shown in FIG. 23, neck 85 and shelf 125 move in the direction of Arrow M, thereby lowering neck 85 into hollow center 69. Top opening 123 on skirt 117 allows neck 85 to telescopically move while having skirt 117 secured about sidewalls 87 of neck. As shown in FIG. 19, while neck 85 is in the first position, skirt 117 is proximate first end 89 of neck 85. As shown in FIG. 24, while neck 85 is in the second position, skirt 117 is proximate second end 91 of neck 85. In the second position, angled surface 119 proximate top opening 123 abuts lower surface 131 of main portion 127 of shelf 125, thereby stopping the vertical movement of neck 85.

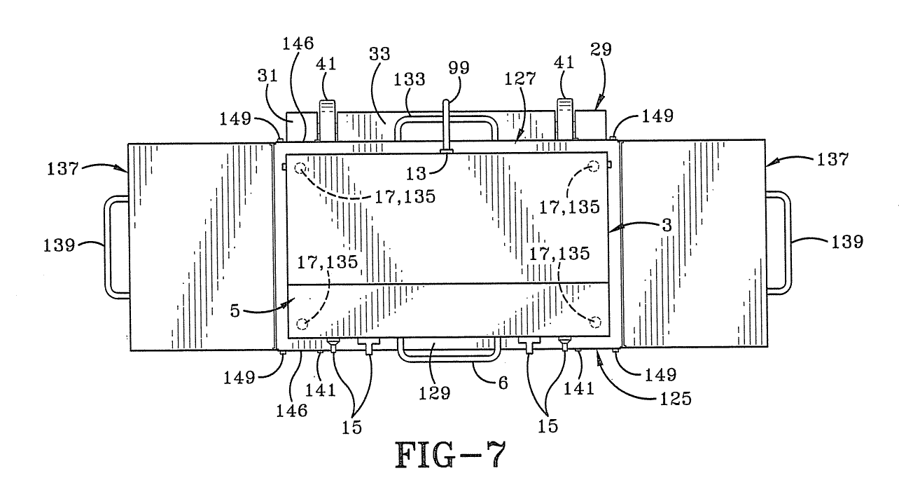

As shown in FIG. 21, when neck 85 is in the second orientation, shelf 125 is no longer complementarily aligned with base 29. In the preferred embodiment of the present invention, base 29 and main portion 127 of shelf 125 are generally the same size and shape, thereby minimizing any container or space the user wishes to enclose pedestal 25 within. As shown in FIG. 7, base 29 and main portion 127 of shelf 125 are generally the same size and complementarily vertically aligned. In the second orientation, main portion 127 of shelf 125 is axially rotated whereby main portion 127 and base 29 are not complementarily vertically aligned. After neck notches 95 pass through body notches 81, the user is free to axially rotate neck 85 back to the first orientation as desired. As shown in FIG. 24, main portion 127 and base 29 are aligned in the second orientation after neck 85 has been lowered from the first position to the second position.

When pedestal 25 has been compressed into the closed position, it requires much less overall space and volume with respect to the open position. This can be seen by comparing the open position of pedestal 25 in FIG. 2, with the closed position of pedestal 25 in FIG. 24. The overall width of pedestal 25 is reduced by rotating side shelves 137 from a horizontal position (FIG. 2) to a vertical position (FIG. 24). Likewise, the overall height of pedestal 25 is reduced by removing grill 3 and compressing neck 85 into hollow center 69 of body 61 (FIG. 24).

As shown in FIG. 25, pedestal 25 may be inserted in a box 170 for storage or shipping. One can readily understand that a much larger box 170 would be required to contain pedestal 25 in the open position, as compared to the closed position of FIG. 25. It is a much desired need in the commercial industry in general, and the grill industry in particular to reduce overall storage and shipping space, which reduces costs. It is a primary feature of the present invention that the manufacturer may ship pedestal 25 in the closed position, the retailer may store and sell pedestal 25 in the closed position, the consumer may purchase pedestal 25 in the closed position, and then change pedestal 25 to the open position after purchase.

It is another feature of the present embodiment that body 61 may be formed of a single sheet of stainless steel. As shown in FIG. 3B, body 61 is a barrel shape having a plurality of flat sidewalls 63 angled with respect to one another and body flanges 75 and lips 79 extending from one sidewall 63 and folded at right angles with respect to the corresponding sidewall 63. Body 61 is cut from a single sheet of stainless steel, and then folded into the desired position. Manufacturing body 61 from a single sheet of material is a very cost effective and efficient building process, and represents a tremendous manufacturing advantage over the prior art. Likewise, as shown in FIG. 3B, neck 85 may also be cut from a single sheet of stainless steel and folded to the desired shape, obtaining all the advantages of cost effectiveness and manufacturing efficiency as discussed above with respect to body 61.

When viewing the present invention with respect to the prior art, the present invention represents and enormous leap in the field of propane tank grills. The present invention allows a user to remove the grill portion and compress the pedestal portion into a much smaller overall shape, requiring much less volume for storage and shipment. Furthermore, the removed grill may be used separate from the pedestal, which broadens the range of possible uses for a standard grill, such as camping or tailgate parties in a stadium parking lot. Major components of the pedestal may be formed of a single piece of stainless steel, such as the body and the neck, resulting in manufacturing efficiencies not seen in the present state of the art. As such, grill pedestal assembly 1 of the present invention represents a novel leap in the field of propane tank grills.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A grill assembly comprising:
a grill;
a pedestal supporting the grill and comprising:
a base;
a body secured to the base;
a neck extending from the base; and
a shelf secured to the neck;
whereby the grill is selectively secured to the shelf.

2. The grill assembly of claim 1, wherein the neck is telescopically moveable between a first position and a second position.

3. The grill assembly of claim 2, wherein the neck is axially rotatable between a first orientation and a second orientation.

4. The grill assembly of claim 3, wherein the neck includes a neck flange and the body includes a body flange, whereby the neck flange abuts the body flange in the first orientation when the neck is in the first position, and whereby the neck flange does not abut the body flange in the second orientation.

5. The grill assembly of claim 4, wherein the body defines a body notch, and wherein the neck flange aligns with the body notch when the neck is in the second orientation to allow the neck flange to pass therethrough as the neck is moved from the first position to the second position.

6. The grill assembly of claim 1, wherein the shelf includes a main portion and at least one side shelf which is rotatable between a generally horizontal plane and a generally vertical plane.

7. The grill assembly of claim 1, further comprising a pair of wheels disposed in the base and a handle disposed on the shelf, wherein the wheels are positioned to allow tilted movement of the grill assembly about a longer edge of the base.

8. The grill assembly of claim 1, further comprising a plurality of feet extending from the grill, and a plurality of recesses in the shelf complementarily shaped and sized to receive the feet therein.

9. The grill assembly of claim 8, further comprising a recess hole disposed in each recess, a threaded hole disposed in each foot, and a plurality of foot screws, whereby a portion of each foot screw may be disposed through the recess hole and into the foot to removably secure the grill to the shelf.

10. The grill assembly of claim 1, wherein the body defines a tank aperture adapted to pass a propane tank therethrough, and wherein the neck defines a hose aperture adapted to pass a propane hose therethrough.

11. The grill assembly of claim 1, wherein the body, neck, and shelf are formed of stainless steel.

12. The grill assembly of claim 1, further including a removable skirt disposed around the neck, wherein the skirt is slidable along a portion of the neck, and wherein the portion is intermediate the body and the shelf.

13. The grill assembly of claim 1, wherein the grill is free of an adjustable grate.

14. The grill assembly of claim 1, wherein the grill is a propane gas grill.

15. The grill assembly of claim 1, wherein one of the neck and body is formed of a single piece of material.

16. The grill assembly of claim 1, wherein the pedestal is movable between an open position having a first minimum storage volume, and a closed position having a second minimum storage volume, and wherein the second minimum storage volume is less than the first minimum storage volume.

17. A pedestal assembly adapted to support a grill, the pedestal assembly comprising:
a base;
a body secured to the base;
a neck extending from the base;
a shelf secured to the neck;
whereby the pedestal assembly is movable between an open position and a closed position; and
wherein the open position includes a first height of the pedestal assembly, and the closed position includes a second height, and wherein the first length is greater than the second length.

18. A method of transporting a pedestal assembly adapted to support a grill, the method comprising:
folding a portion of a shelf secured to the neck;
telescopically lowering a portion of a neck into a body secured to a base;
moving the pedestal assembly to a different location;
telescopically raising the portion of the neck; and
unfolding the portion of the shelf.

19. The method of transporting the pedestal assembly of claim 18, further comprising:
receiving the pedestal assembly with the neck in a first orientation;
axially rotating the neck from the first orientation to a second orientation;
telescopically inserting a portion of the neck into the body while the neck is in the second orientation; and
axially rotating the neck from the second orientation to the first orientation.

20. The method of transporting the pedestal assembly of claim 19, further comprising axially rotating the neck to move a neck flange formed on the neck away from an abutting relationship with a body flange formed on the body.

21. The method of transporting the pedestal assembly of claim 20, further comprising aligning the neck flange with a notch defined by the body, and passing the neck flange through the notch such that a portion of the neck is inserted into the body.

22. The method of transporting the pedestal assembly of claim 19, further comprising the step of removing the grill from the shelf.
